(19) United States
(12) Patent Application Publication
(10) Pub. No.: US 2011/0317522 A1
(43) Pub. Date: Dec. 29, 2011

(54) SOUND SOURCE LOCALIZATION BASED ON REFLECTIONS AND ROOM ESTIMATION

(75) Inventors: Dinei Afonso Ferreira Florencio, Redmond, WA (US); Cha Zhang, Sammamish, WA (US); Flavio Protasio Ribeiro, Sao Paulo (BR); Demba Elimane Ba, Somerville, MA (US)

(73) Assignee: MICROSOFT CORPORATION, Redmond, WA (US)

(21) Appl. No.: 12/824,248

(22) Filed: Jun. 28, 2010

(51) Int. Cl. G01S 3/80

(52) U.S. Cl. 367/129; 367/118

(57) ABSTRACT

Described is modeling a room to obtain estimates for walls and a ceiling, and using the model to improve sound source localization by incorporating reflection (reverberation) data into the location estimation computations. In a calibration step, reflections of a known sound are detected at a microphone array, with their corresponding signals processed to estimate wall (and ceiling) locations. In a sound source localization step, when an actual sound (including reverberations) is detected, the signals are processed into hypotheses that include reflection data predictions based upon possible locations, given the room model. The location corresponding to the hypothesis that matches (maximum likelihood) the actual sound data is the estimated location of the sound source.

### BACKGROUND

Sound source localization (SSL) generally refers to determining the source of a sound, and is used in many applications involving speech capture and enhancement. For example, in order to provide high quality audio without constraining users to have speak closely into microphones, a centralized microphone array can be electronically steered to emphasize an signal coming from one direction of interest and reject noise coming from other locations. Microphone arrays are thus progressively gaining popularity in applications such as videoconferencing, smart rooms and human-computer interaction.

One of the problems with localizing the sound source based on the signal arriving at a microphone array is that sound coming directly from the source is also indirectly received from other directions due to reflections (reverberations). In some situations, the indirectly received sound is strong from the early reflections, possibly even stronger than the sound from the direct source. Thus it is hard to find the direction of a sound source when the arriving sound comes, in fact from multiple directions, only one of which is the desired location.

Techniques to account for the reverberation attempt to estimate the reverberation in a room and treat the reverberation as interference. This is generally done by modeling the room impulse response. However, room impulse responses change quickly with speaker position, and are nearly impossible to track accurately.

In practice, common to any of these known techniques is that performance decreases with increasing reverberation. Any improvement in sound source localization and/or room modeling is thus desirable.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which reflection data in conjunction with a room estimate are used to improve sound source localization. The room estimate is used in computing hypotheses corresponding to predicted sound characteristics (including reverberation) at different locations in a room. When sound from an actual sound source is detected at a microphone array, the signals are processed to obtain the actual sound's characteristics and the hypotheses, which then are matched to find the best matching hypothesis (or hypotheses) that corresponds to an estimated location of the sound source.

In one aspect, a room is modeled to obtain the room (walls and ceiling) locations. A calibration sound such as a sine sweep is output into the room, and the reflections detected at a microphone array. The signals from the microphone array corresponding to the reflections are processed to obtain functions (comprising distance, azimuth and elevation data) corresponding to a set of candidate wall locations. These functions are processed (e.g., via L1-regularization) to obtain a sparse set (subset) of candidate wall locations. Post-processing may be performed to select candidate wall locations that represent a generally rectangular room with a single ceiling). The functions also may contain reflection coefficient data, on which computations (e.g., least squares) may be performed to select reflection coefficients for the candidate wall locations.

In one aspect, a sound source localization mechanism uses a room model estimate to predict early reflections. To estimate a location of a source of sound from signals output by a microphone array for that sound, a set of hypotheses corresponding to different locations in the room are computed, including based on sound characteristics that include the predicted early reflection data. The location is estimated by matching (via maximum likelihood) the characteristics of the sound to one of the hypotheses.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing an audio processing environment in which reflections are incorporated into sound source localization based upon room modeling/estimation.

FIG. 2 is a representation of a device modeling a room in a calibration step by processing audio reflections.

FIG. 3 is a representation of a device detecting direct and reflected sound from an actual sound source for sound source localization processing.

FIG. 4 is a representation of a range discrimination problem in sound source localization when detecting sound from two sound sources substantially in the same direction.

FIG. 5 is a representation of how reflections, when processed with sound source localization that includes reflection data, overcome the range discrimination problem.

### DETAILED DESCRIPTION

Various aspects of the technology described herein are generally directed towards incorporating a room model into sound source location estimation. In general, once the room is modeled relative to a microphone array, the reflections may be estimated for any source location, which can change as the speaker moves. The modeling not only compensates for the reverberation, but also significantly increases resolution for range and elevation; indeed, under certain conditions, reverberation can be used to improve sound source localization performance.

In one implementation, a calibration step obtains an approximate model of a room, including the locations and characteristics of the walls and the ceiling (which may be considered a wall). This approximate model is used to predict reflections, and thus account for the reflections from a sound source.

It should be understood that any of the examples herein are non-limiting. For example, while a number of ways to obtain a room estimate are described, reflection predictions may be made from any reasonable room estimate, including one made by manual measurements. Similarly, the room estimation technology described herein may be used in applications other than sound source localization. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in sound technology in general.

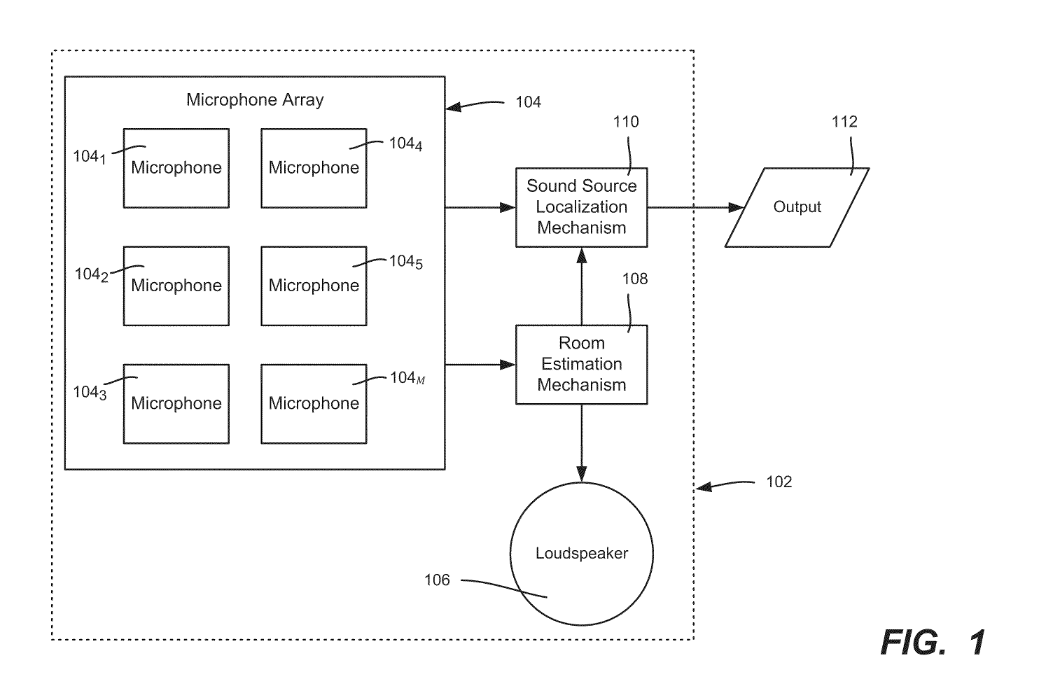

FIG. 1 is a block diagram showing a system 102 comprising a plurality of microphones 104₁-104_{M} (collectively referred to as a microphone array 104), and further including a loudspeaker 106. The system 102 includes a room estimation mechanism 108 which in general operates by driving the loudspeaker 106 and detecting sounds via each of the microphones 104₁-104_{M} as described below. The room estimates are provided to a sound source localization mechanism 110, which then provides sound source localized output 112, (which may be speech enhanced). Note that for clarity, FIG. 1 shows the microphone array 104 coupled to the room estimation mechanism 108 and the sound source localization mechanism 110, however it is understood that signals from each of the individual microphones 104₁-104_{M} are separately received at these mechanisms. In general, the room estimation mechanism 108 and/or the sound source localization mechanism 110 comprise an audio processing environment, using one or more computer-based processors.

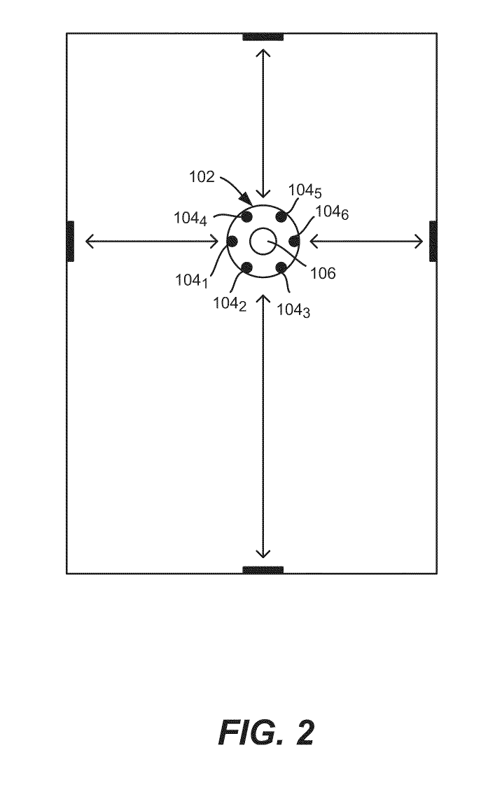

A more particular implementation of the system 102, such as constructed as a single device, is represented in FIG. 2, which arranges the microphones 104₁-104₆ in a uniformly circular array with the loudspeaker 106 rigidly mounted in its center; this is the geometry used by Microsoft Corporation's RoundTable® device, for example. As can be readily appreciated, however, other microphone array and/or loudspeaker configurations may benefit from the technology described herein. Indeed, the array may be generally described as being comprised of M microphones and N loudspeakers, where M and N are any practical number, not necessarily M=6 and N=1, as shown in FIG. 2. Notwithstanding, it is assumed that the geometry of the array 104 is fixed and known in advance, or that it can be computed.

As also shown in FIG. 2, the system 102 is within a three-dimensional room having a ceiling and four walls, (along with a floor and other sound reflective surface such as a conference table on which the device rests). For purposes of simplicity, however, the room is shown in two dimensions. The walls are represented by the solid black rectangle bordering the device, which is generally centralized (but not necessarily centered) in this example. Note that the walls need not be made from the same material, e.g., one may be glass while the others may be painted drywall, meaning they may have different (acoustic) reflection coefficients.

In order to determine the room's acoustic characteristics, the device actively probes the room by emitting a known signal (e.g., a three-second linear sine sweep from 30 Hz to 8 kHz) from a known location, which in this example is the known location of the loudspeaker 106 co-located with the array 104. Note that the loudspeaker 106 is a single, fixed sound source that is close to the microphones 104₁-104₆ in this example, which implies that each wall is only sampled at one point, namely the point where the wall's normal vector points to the array. These points are represented by the black segments on the lines representing the walls. If other loudspeakers were available at other location, more estimates of the wall could be obtained at other segments. Note also that, even if using a single microphone, if second order reflections are considered, then sampling is not limited to estimating at only the points represented by the black segments.

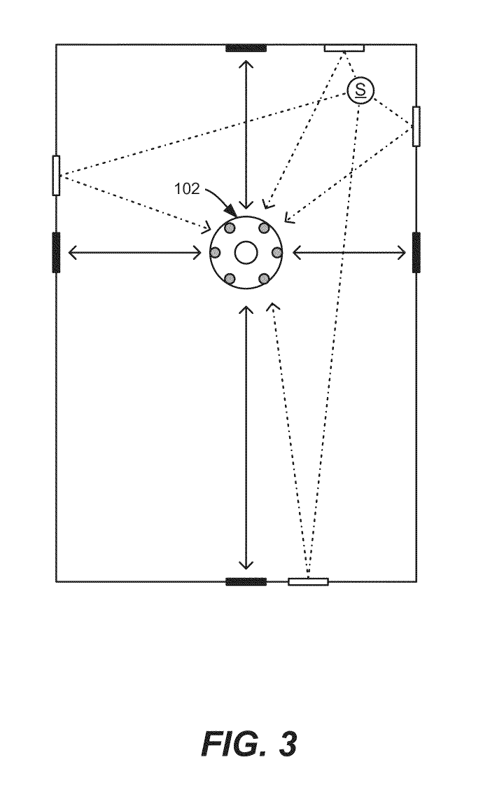

Depending on the application, the walls extend beyond the location at which they are detected. FIG. 3 illustrates this concept when using the room model to perform speech enhancement or sound source localization from an actual source S. During the probe, the system 102 detects the reflections from the walls, as indicated by the solid black lines and black segments in each of the four walls. However, in the example of FIG. 3 where the source S is located elsewhere, the locations of interest for the walls are the ones indicated by the white segments, as those segments are the ones from which the reflections from the actual source S are received, as represented by the dashed/dotted lines.

As described below, during calibration, the sounds that are reflected back to the microphones are recorded as functions of the reflection coefficient, distance, azimuth and elevation. There is a large number of such functions, and thus a sparse solution is used.

An underlying assumption is that the walls extend linearly and have reasonably consistent acoustic characteristics; this assumption is for practicality, and because most conference rooms meet this criteria. Thus, in the illustrated example of FIGS. 2 and 3, the modeling problem is that of fitting a five-wall model (considering the ceiling as another wall) to a three-dimensional enclosure based on data recorded by an array 104 of M microphones, by reproducing a known signal such as a sine sweep from a source (the loudspeaker 106) positioned at the center of the array 104.

The room model is denoted R={(aᵢ, dᵢ, θᵢ, φᵢ)}ᵢ₌₁⁵ where the vector (aᵢ, dᵢ, θᵢ, φᵢ) specifies, respectively, the reflection coefficient, distance, azimuth and elevation of the i^{th} wall with relation to a known coordinate system. For a number of reasons, a completely parametric approach to this problem, in which R is estimated directly, is not appropriate, and thus a non-parametric approach is used, which assumes that early segments of impulse responses can be decomposed into a sum of isolated wall reflections.

Without loss of generality, a spherical coordinate system (r, θ, φ) is defined such that r is the range, θ is the azimuth, φ is the elevation and (0, 0, 0) is at the phase center of the array. The geometry of the array and loudspeaker is fixed and known. Define hₘ^{(r,θ,φ)}(n) as the discrete time impulse response from the loudspeaker to the m^{th} microphone, considering that the direct path from the loudspeaker 106 to each microphone in the array 104 has been removed, and that the array 104 is mounted in free space, except for the presence of a lossless, infinite wall with normal vector n=(r, θ, φ) and which contains the point (r, θ, φ).

Let r be sufficiently large so that the wall does not intersect the array or offer significant near-field effects, and denote h(r,θ,φ)m(n) as a single wall impulse response (SWIR). The discrete time observation model is:

yₘ(n)=hₘ(n)*s(n)+uₘ(n), (1)

where n is the sample index, m is the microphone index, hₘ(n) is the room's impulse response from the array center to the m^{th} microphone, s(n) is the reproduced signal, and uₘ(n) is measurement noise. Given a persistently exciting signal s(n), the room impulse responses (RIRs) may be estimated from the observations yₘ(n). It is from these estimates that the geometry of the room is inferred. Assume that the early reflections from an arbitrary RIR hₘ(n) may be approximately decomposed into a linear combination of the direct path and individual reflections, such that

$${h}_{m} ( n ) \approx {h}_{m}^{( dp )} ( n ) + {\sum }_{i = 1}^{R} {ρ}^{( i )} {h}_{m}^{( {r}_{i} , {θ}_{i} , {φ}_{i} )} ( n ) + {v}_{m} ( n ) , \qquad ( 2 )$$

where hₘ^{(dp)}(n) is the direct path; R is the total number of modeled reflections; i is the reflection index; hₘ^{(ri,θi,φi)}(n) is the SWIR from a perfectly reflective wall at position (rᵢ,θᵢ,φᵢ), and from which the direct path from the loudspeaker to the microphone has been removed; ρ⁽ⁱ⁾ is the reflection coefficient (assumed to be frequency invariant); vₘ(n) is noise and residual reflections not accounted in the summation.

Note that it is assumed that ρ⁽ⁱ⁾ does not depend on m; more particularly, while the reflection coefficient depends on a wall and not on the array, it is conceivable (albeit unlikely) that the sound impinging on a pair of microphones may have reflected off different walls. However, for reasonably small arrays, the sound will take approximately the same path from the source to each of the microphones, which implies that (with high probability) it reflects off of the same walls before reaching each microphone, such that the reflection coefficients are the same for every microphone: Define

xₘ=[χₘ(0) . . . χₘ(N)]^{T}

x=[x₁^{T} . . . x_{M}^{T}]^{T}

x_{m,τ}=[χₘ(τ) . . . χₘ(N+τ)]^{T}

x_{T}=[x_{1,τ}^{T} . . . x_{M,τ}^{T}]^{T}

for any signal xₘ(n) associated with the M^{th} microphone. Equation (2) can then be rewritten in truncated vector form as:

$$h \approx {h}^{( dp )} ( n ) + {\sum }_{i = 1}^{R} {ρ}^{( i )} {h}^{( {r}_{i} , {θ}_{i} , {φ}_{i} )} + v , \qquad ( 3 )$$

where a vector length N is selected that is just large enough to contain the first order reflections, but that cuts off the higher order reflections and the reverberation tail. Therefore, given a measured h, the problem is to estimate ρ⁽ⁱ⁾ and rᵢ, θᵢ, φᵢ for the dominant first order reflections, which in turn reveal the position of the closest walls and their reflection coefficients.

The method for room modeling comprises obtaining synthetically and/or experimentally for the array of interest, namely a set {h^{(r}^{₀}^{θ,0)}}_{θεA} of SWIRs, each measured at fixed range r=r₀ over a grid A of azimuth angles, and the SWIR {h(^{r}^{₀}^{θ,π/2)}} containing only the reflection from a ceiling at the same fixed range. Define

H={h^{(r}^{₀}^{,θ,0)}}_{θεA}∪{h^{(r}^{₀}^{,0,π/2)}}. (4)

In essence, H carries a time-domain description of the array manifold vector for multiple directions of arrival. If a far field approximation and a sufficiently high sampling rate is assumed, given an arbitrary h^{(r}^{_{*,}}^{θ}^{_{*}}^{φ}^{_{*}}⁾ with r_{*}>r₀:

$${h}^{( {r}_{*} , {θ}_{*} , {φ}_{*} )} \approx \frac{{r}_{0}}{{r}_{*}} {h}_{{τ}_{*}}^{( {r}_{0} , {θ}_{*} , {φ}_{*} )} , \qquad ( 5 )$$

for τ_{*}=[2(r_{*}−r₀)/c], where [*] denotes the nearest integer, and c is the speed of sound. Thus, h^{(r}^{₀}^{,θ}^{_{*}}^{φ}^{_{*}}⁾ generates a family of reflections for a given direction. Because a room is essentially a linear system, if it is assumed that reflection coefficients are frequency-independent and neglect the direct path from the loudspeaker to the microphones, the first order reflections can be expressed as a linear combination of time-shifted and attenuated SWIRs.

Furthermore, if A is sufficiently fine, for a set of walls W={(rᵢ, θᵢ, φᵢ)}_{iε|1,W|} there are coefficients {ci}_{iε|1,W|} such that given an impulse response hᵣₒₒₘ, which had the direct path removed and was truncated as to only contain early reflections,

$${h}_{room} \approx {\sum }_{i ∈ [ 1 , W ]} {c}_{i} {h}^{( {r}_{0} , {θ}_{i} , {φ}_{i} )} . \qquad ( 6 )$$

Thus, under the approximations above, the set of all delayed SWIRs approximately generates the space of truncated impulse responses over which the estimations are made. Define H_{*}={h_{τ}:hεH [symbol] 0≦τ≦T}, where T is the maximum delay to model for a reflection. The problem is then to fit elements H_{*} to the measured impulse response, adjusting for attenuation.

A sparse solution is also required, given that only a few major first order reflections are of interest, and that H_{*} will contain a very large number of candidate reflections. Consider an enumeration of H such that H={h⁽¹⁾, . . . , h^{(K)}}, with K=|H|, and define:

H=[h_{τ=0}⁽¹⁾ . . . h_{τ=T}⁽¹⁾ . . . h_{τ=0}^{(K)} . . . h_{τ=T}^{(K)}], (7)

where each single wall impulse response appears for each integer delay τ such that 0≦τ≦T. For sparsity, the following l₁-regularized (“L1-regularization”) least-squares problem is solved:

$${min}_{a} {‖ {h}_{room} - Ha ‖}_{2}^{2} + λ {‖ a ‖}_{1} , \qquad ( 8 )$$

where λ controls the sparsity of the desired solution. Each coefficient in the solution indicates a reflection, and assume each reflection is from a different wall. Thus, there is a need to use a sparsity-inducing penalty as the norm. Without it, a typical minimum mean square solution will provide hundreds or thousands of small-valued reflections, instead of the few strong reflections corresponding to the wall candidates. If only SWIRs with coefficients [a]ᵢ larger than a given threshold are considered, there is set of candidate walls. A post-processing stage is performed in order to only accept solutions which contain walls which make ninety degree angles to each other, and reject impossible solutions such as more than one ceiling or multiple walls at approximately the same direction.

A practical consideration involves the computational tractability of solving equation (8). It is desirable to have spatial resolutions on the order of two centimeters or better. Given the restriction of integer delays, this translates into having a sampling rate of 16 kHz or higher. To identify walls located at four meters or less, a round-trip time of around 350 samples needs to be planned, which implies allowing 0≦τ≦350=T. The grid of single wall reflections needs to be sufficiently fine, otherwise walls will not be detected.

Sampling in azimuth with four degrees resolution results in 90 SWIRs. One SWIR for the ceiling is also necessary, giving K=90+1. Therefore, H has T·K=31,850 columns. Because impulse responses can be long, computational requirements for operating explicitly with H will typically be prohibitive. In order to solve equation (8) in a known manner, the H^{x} and H^{T}y operations for arbitrary vectors x and y need to be implemented. To this end, it is possible to exploit H's block matrix nature in order to avoid representing H explicitly, and also to accelerate the matrix-vector product operations. Indeed, H has a block structure:

H=[H⁽¹⁾ H⁽²⁾ . . . H^{(K)}], (9)

where

H⁽ⁱ⁾=[h_{τ=0}⁽ⁱ⁾ h_{τ=1}⁽ⁱ⁾ . . . h_{τ=T}⁽ⁱ⁾]. (10)

For all i, H(i) is Toeplitz. Therefore, H⁽ⁱ⁾x=h_{τ=0}⁽ⁱ⁾*x, which can be implemented with a fast FFT-based convolution, and

[H⁽ⁱ⁾]^{T}y=h_{τ=0}⁽ⁱ⁾*y

(where * denotes cross-correlation), which can also be evaluated with FFTs. Using this method, both matrix-vector products can be performed using K fast convolutions or fast correlations. Additional information may be found in the reference by S. J. Kim, K. Koh, M. Lustig, S. Boyd, and D. Gorinevsky, entitled, “An interiorpoint method for large-scale II-regularized least squares,” IEEE Journal of Selected Topics in Sig. Proc., vol. 1, no. 4, pp. 606-617,2007.

After solving equation (8) and post processing to reject invalid walls, only relatively few wall coordinates and their associated coefficients

$${[ a ]}_{i} = {ρ}^{( i )} \cdot \frac{{r}_{0}}{{r}^{( i )}}$$

remain. It turns out that

r⁽ⁱ⁾=r₀+mod(i−1,T)/(2fₛ), (11)

where fₛ is the sampling rate, whereby ρ⁽ⁱ⁾ is able to be estimated. Note that the l₁-regularized least-squares procedure is designed for producing sparse solutions, and as such, tends to underestimate coefficients, such that reflection coefficients obtained directly from solving equation (8) can be too small. To get better estimates of reflection coefficients, only the h_{τ=τ}_{ᵢ}⁽ⁱ⁾ single wall responses corresponding to the identified walls are gathered, fitted to the measured impulse response using conventional least squares.

Another consideration is how to preprocess impulse responses before solving equation (8). Individual single wall reflections tend to be very short, while the impulse response hᵣₒₒₘ is usually long, and contains many features other than the first reflections that it may be desirable to identify with greater precision. These features can be due to clutter, multiple reflections, bandpass responses from microphones or reflections from the table over which the array is set. In order to reduce these extraneous features, soft thresholding on SWIRs and room RIRs may be performed, according to:

hₜₕᵣₑₛₕ=sign(h)·max(|h|−σ,0), (12)

where σ determines the thresholding level and may be adjusted as a fraction of the signal's level. With soft thresholding, the RIR gains the appearance of a synthetic impulse response generated using an image method. The sparsity of the thresholded RIR lends well to the l₁-constrained least squares procedure, both in running time and estimation precision.

As described below, a sound source localization (SSL) algorithm is based on using a room model to estimate and predict early reflections. Note that while the above-described room modeling technique provides reasonable results, and is practical for use in meeting rooms or homes, the SSL algorithm is not limited to the above-described modeling technique. For example, professional measurement of the size, distance and reflection coefficients may be made for auditoriums, amphitheaters and other large, instrumented rooms. Further, extensive research exists for obtaining 3D models based on video and images. Common passive methods include depth from focus, depth from shading, and stereo edge matching, while active methods include illuminating the scene with laser, or with structured or patterned infrared light. Further a combined solution may be used, such as a more complex 3D model obtained via a combination of acoustic and visual measurements, e.g., acoustic measurements may be performed during setup to estimate the general room geometry and reflection coefficients, while visual information may be used during a meeting to account for people moving. Notwithstanding, SSL is described herein generally with reference to the above-described room modeling technique.

In general, SSL using a maximum likelihood technique operates by computing hypotheses for a grid of possible locations for a sound source in a room, one hypothesis for each location. Then, when sound is received, the characteristics of that sound are matched against the hypotheses to find the one with the maximum likelihood of being correct, which then identifies the source location. Such a technique is described in U.S. published patent application no. 20080181430, herein incorporated by reference. As described herein, a similar technique is used, except that the characteristics of the sound now include reflection data based upon the room estimates. As will be seen, by including reflection data, reverberations often help rather than degrade sound source localization.

Consider an array of M microphones in a reverberant environment. Given a signal of interest s(n) with frequency representation S(ω), a simplified model for the signal arriving at each microphone is:

Xᵢ(ω)=αᵢ(ω)e^{-jωτi}S(ω)+Hᵢ(ω)S(ω)+Nᵢ(ω), (13)

where iε{1, . . . , M} is the microphone index; τᵢ is the time delay from the source to the i^{th} microphone; αᵢ(ω) is a microphone dependent gain factor which is a product of the i^{th} microphone's directivity, the source gain and directivity, and the attenuation due to the distance to the source; Hᵢ(ω)S(ω) is a reverberation term corresponding to the room's impulse response minus the direct path, convolved with the signal of interest; Nᵢ(ω) is the noise captured by the i^{th} microphone.

A more elaborate version of equation (13) can be obtained by explicitly considering R early reflections. In this case, Hᵢ(ω)S(ω) only models reflections that were not explicitly accounted for. The microphone signals can then be represented by:

$${X}_{i} ( ω ) = {\sum }_{r = 0}^{R} {α}_{i}^{( r )} ( ω ) {e}^{- {jωτ}_{i}^{( r )}} S ( ω ) + {H}_{i} ( ω ) S ( ω ) + {N}_{i} ( ω ) , \qquad ( 14 )$$

where αᵢ^{(r)}(ω) is a gain factor which is a product of the i^{th} microphone's directivity in the direction of the r^{th} reflection, the source gain and directivity in the direction of the r^{th} reflection, the reflection coefficient for r^{th} reflection, and the attenuation due to the distance to the source; τᵢ^{(r)} is the time delay for the r^{th} reflection. Also defined are αᵢ⁽⁰⁾(ω)=αᵢ(ω) and τᵢ⁽⁰⁾=τᵢ which correspond to the direct path signal.

When early reflections are modeled, traditional SSL algorithms cannot be applied. The following sets forth a scheme that models early reflections as a whole, which results in a maximum likelihood algorithm that is both accurate and efficient.

Let Gᵢ(ω)=Σᵣ₌₀^{R}αᵢ^{(r)}(ω)e^{-jωτ}^{ᵢ}^{(r)}, which is further decomposed into gain and phase shift components Gᵢ(ω)=gᵢ(ω)e^{-jφ}^{ᵢ}^{(ω)}, where:

$$\begin{matrix}{g}_{i} ( ω ) = \vert {\sum }_{r = 0}^{R} {α}_{i}^{( r )} ( ω ) {e}^{- {jωτ}_{i}^{( r )}} \vert & ( 15 ) \\ {e}^{- {jϕ}_{i} ( ω )} = \frac{{\sum }_{r = 0}^{R} {α}_{i}^{( r )} ( ω ) {e}^{- {jωτ}_{i}^{( r )}}}{\vert {\sum }_{r = 0}^{R} {α}_{i}^{( r )} ( ω ) {e}^{- {jωτ}_{i}^{( r )}} \vert} . & ( 16 )\end{matrix}$$

The phase shift components are further approximated by modeling each αᵢ^{(r)}(ω) with only attenuations due to reflections and path lengths, such that

$${e}^{- {jϕ}_{i} ( ω )} \approx \frac{{\sum }_{r = 0}^{R} \frac{{ρ}_{i}^{( r )}}{{r}_{i}^{( r )}} {e}^{- {jωτ}_{i}^{( r )}}}{\vert {\sum }_{r = 0}^{R} \frac{{ρ}_{i}^{( r )}}{{r}_{i}^{( r )}} {e}^{- {jωτ}_{i}^{( r )}} \vert} , \qquad ( 17 )$$

where rᵢ⁽⁰⁾ and rᵢ^{(r)} are respectively the path lengths for the direct path and r^{th} reflection; ρᵢ⁽⁰⁾ and ρᵢ^{(r)} is the r^{th} reflection coefficient. Note that reflection coefficients are assumed to be frequency independent. As described below, gᵢ(ω) can be estimated directly from the data, such that it need not be inferred from the room model and thus does not require a similar approximation.

Using e^{-jφ}^{ᵢ}^{(ω)}, equation (14) can be rewritten as

Xᵢ(ω)=gᵢ(ω)e^{-jφ}^{₁}^{(ω)}S(ω)+Hᵢ(ω)S(ω)+Nᵢ(ω) (18)

Even if reflection coefficients are frequency dependent, they can be decomposed into constant and frequency dependent components, such that the frequency dependent part which represents a modeling error is absorbed into the Hᵢ(ω)S(ω) term. In general, all approximation errors involving αᵢ^{(r)}(ω) can be treated as unmodeled reflections, and thus absorbed into Hᵢ(ω)S(ω). Even if there are modeling errors, if the reflection modeling term gᵢ(ω)e^{-jφ}^{ᵢ}^{(ω)} is able to reduce the amount of energy carried by Hᵢ(ω)S(ω)+Nᵢ(ω), there is an improvement over using equation (13).

Rewriting equation (18) in vector form provides:

X(ω)=S(ω)G(ω)+S(ω)H(ω)+N(ω), (19)

where
X(ω)=[X₁(ω), . . . , X_{M}(ω)]^{T}
G(ω)=[g₁(ω)e^{-jφ}^{₁}^{(ω)}, . . . , g_{M}(ω)e^{-jφ}^{_{M}}^{(ω)}]^{T}
H(ω)=[H₁(ω), . . . , H_{M}(ω)]^{T}
N(ω)=[N₁(ω), . . . , N_{M}(ω)]^{T}

Turning to a noise model, assume that the combined noise

N^{c}(ω)=S(ω)H(ω)+N(ω) (20)

follows a zero-mean, independent between frequencies, joint Gaussian distribution with a covariance matrix given by:

$$\begin{matrix}Q ( ω ) = E \{ {{N}^{c} ( ω ) [ {N}^{c} ( ω ) ]}^{H} \} \\ = E \{ N ( ω ) {N}^{H} ( ω ) \} + {\vert S ( ω ) \vert}^{2} E \{ H ( ω ) {H}^{H} ( ω ) \} .\end{matrix} \qquad ( 21 )$$

Making use of a voice activity detector, E{N(ω) [N(ω)]^{H}} can be directly estimated from audio frames that do not contain speech. For simplicity, assume that noise is uncorrelated between microphones, such that:

E{N(ω)N^{H}(ω)}≈diag(E{|N₁(ω)|²}, . . . , E{|N_{M}(ω)|²}). (22)

It is also assumed that the second noise term is diagonal, such that

$$\begin{matrix}{\vert S ( ω ) \vert}^{2} E \{ H ( ω ) {H}^{H} ( ω ) \} \approx diag ( {λ}_{1} , … , {λ}_{M} ) & ( 23 ) \\ with & \\ {λ}_{i} = E \{ {\vert S ( ω ) \vert}^{2} {\vert {H}_{i} ( ω ) \vert}^{2} \} & ( 24 ) \\ \approx γ ( {\vert {X}_{i} ( ω ) \vert}^{2} - E \{ {\vert {N}_{i} ( ω ) \vert}^{2} \} ) , & ( 25 )\end{matrix}$$

where 0<γ<1 is an empirical parameter that models the amount of reverberation residue, under the assumption that the energy of the unmodeled reverberation is a fraction of the difference between the total received energy and the energy of the background noise. This model has been used successfully for cases where reflections were not explicitly modeled (R=0 in (equation 17)), and good results have be achieved for a wide variety of environments with 0.1<γ<0.3.

In reality, neither E{N(ω)N^{H}(ω)} nor |S(ω)|²E{N(ω)H^{H}(ω)} should be diagonal. In particular, any noise component due to reverberation needs to be correlated between microphones. However, estimating Q(ω) would become significantly more expensive if not for these simplifications, and the algorithm's main loop would become significantly more expensive as well, because it requires computing Q⁻¹(ω). In addition, the above assumptions do produce satisfactory results in practice. Under the assumptions above,

Q(ω)=diag(κ₁, . . . , κ_{M}) (26)

κᵢ=γ|Xᵢ(ω)|²+(1−γ)E{|Nᵢ(ω)|²} (27)

such that Q(ω) is easily invertible, and can be estimated with a voice activity detector.

Turning to the maximum likelihood framework, the log-likelihood for receiving X(ω) can be obtained in a known manner, and (neglecting an additive term which does not depend on the hypothetical source location) the log-likelihood is given by:

$$J = {\int }_{ω} \frac{1}{{\sum }_{i = 1}^{M} {\vert {g}_{i} ( ω ) \vert}^{2} / {κ}_{i}} {\vert {\sum }_{i = 1}^{M} \frac{{g}_{i}^{*} ( ω ) {X}_{i} ( ω ) {e}^{{jϕ}_{i} ( ω )}}{{κ}_{i}} \vert}^{2} d ω . \qquad ( 28 )$$

The gain factor gᵢ(ω) can be estimated by assuming

|gᵢ(ω)|²|S(ω)|²≈|Xᵢ(ω)|²−κᵢ, (29)

i.e., that the power received by the i^{th} microphone due to the anechoic signal of interest and its dominant reflections can be approximated by the difference between the total received power and the combined power estimates for background noise and residual reverberation. Inserting equation (27) into equation (29) and solving for gᵢ(ω) gives

gᵢ(ω)={square root over ((1=γ)(|Xᵢ(ω)|²−E{|Nᵢ(ω)|²}))}/|S(ω)|. (30)

Substituting equation (30) into equation (28),

$$J = {\int }_{ω} \frac{{\vert {\sum }_{i = 1}^{M} \frac{1}{{κ}_{i}} \sqrt{{\vert {X}_{i} ( ω ) \vert}^{2} - E \{ {\vert {N}_{i} ( ω ) \vert}^{2} \}} {X}_{i} ( ω ) {e}^{{jϕ}_{i} ( ω )} \vert}^{2}}{{\sum }_{i = 1}^{M} \frac{1}{{κ}_{i}} ( {\vert {X}_{i} ( ω ) \vert}^{2} - E \{ {\vert {N}_{i} ( ω ) \vert}^{2} \} )} d ω . \qquad ( 31 )$$

The proposed approach for SSL comprises evaluating equation (31) over a grid of hypothetical source locations inside the room, and returning the location for which it attains its maximum. In order to evaluate equation (31), the reflections to use in equation (17) need to be known. Given the location of the walls provided by the room modeling step, it is assumed that the dominant reflections are the first and second order reflections originating from the closest walls. Using a known image model, the contribution due to first and second order reflections in terms of their amplitude and phase shift are analytically determined, which allows us to evaluate equation (17) and, in turn, equation (19). Experimental data show that considering reflections from only the ceiling and one close wall is sufficient for accurate SSL.

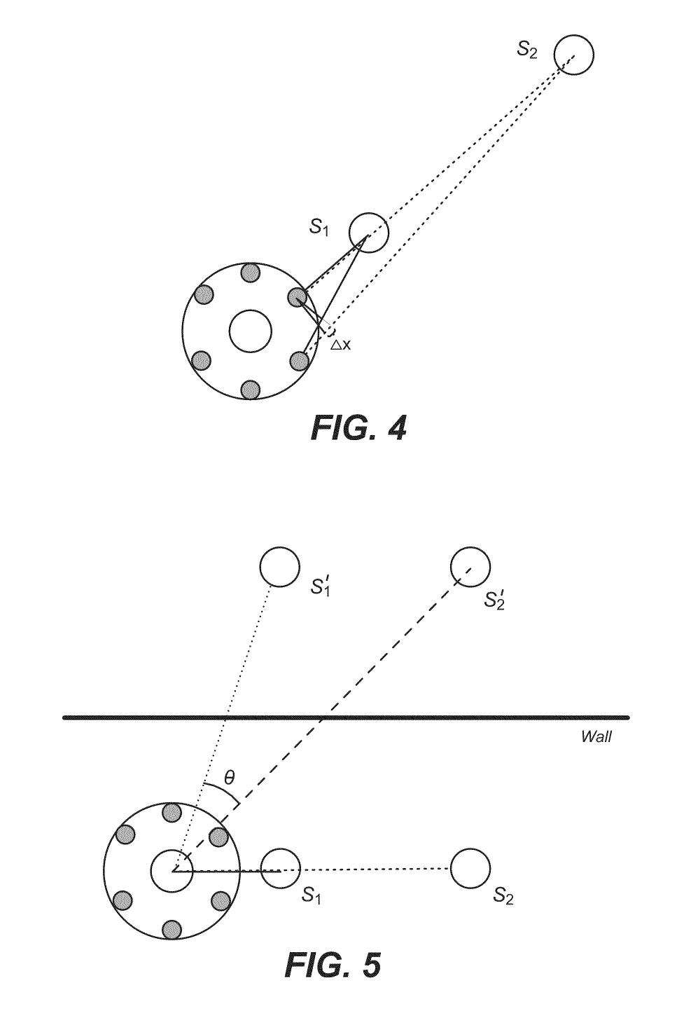

FIGS. 4 and 5 demonstrate why the above-described SSL algorithm is effective. In FIG. 4, there is a range discrimination problem for a six element circular array, because the ranges to sources S₁ and S₂ can be discriminated only by implicitly or explicitly estimating Δx, which corresponds to the difference between time difference of arrival (TDOAs). Further, as S₁ and S₂ get closer to one another Δx approaches zero. For compact arrays, Δx is very small and its estimation is very sensitive to noise and reverberation.

In FIG. 5, consider two sources S₁ and S₂ that have the same azimuth and elevation angles with respect to the array. It is very difficult to discriminate between both sources by using only the direct path TDOAs.

However, consider image sources S₁′ and S₂′, which appear due to reflections off a wall. The microphone array has good resolution in azimuth, so it can easily distinguish between S₁′ and S₂′. In reality the microphone array always acquires the superposition of the direct path and several strong reflections, so it cannot isolate the contributions of S₁′ and S₂′ from those due to S₁ and S₂. Nevertheless, because the signals emitted by S₁ and S₂ have nearly identical sets of phase shifts at the microphones, and because signals emitted by S₁′ and S₂′ have significantly different sets of phase shifts, their superposition results in measurably different sets of phase shifts for the sources. Thus, the detection problem for which the array had no resolution capability has been transformed into a problem that can be solved.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. A method performed on at least one processor, comprising, estimating a location of a signal source in a reflective environment, based on using signals acquired by one or more sensors and a model for locations and behavior of reflectors contained in the environment.

2. The method of claim 1 wherein estimating the location of the signal source is performed in an audio processing environment, wherein the sensors comprise microphones, and wherein the reflectors comprise at least one wall, a ceiling or one or more other obstacles, or any combination of at least one wall, a ceiling or one or more other obstacles.

3. The method of claim 1 wherein estimating the location of the signal source includes predicting early reflections based on the model for the location and behavior of the reflectors.

4. The method of 3, wherein estimating the location of the signal source comprises testing a number of possible source locations, and computing a maximum likelihood estimate for each source location.

5. The method of claim 1 wherein estimating the location of the signal source includes, predicting early reflections, and estimating a location of a sound source using signals output by a microphone array, including providing a plurality of hypotheses, each hypothesis corresponding to a different location in a room corresponding to the room model, the hypotheses based on sound characteristics including predicted early reflection data, and selecting an estimated location of the sound source by matching characteristics of a sound received from the sound source with one of the hypotheses.

6. The method of claim 5 wherein the sound source outputs speech, and wherein the hypotheses include noise data measured when no speech is detected.

7. The method of claim 1 wherein estimating the location comprises using first and second order reflections originating from at least one closest estimated wall or an estimated ceiling in the model, or from at least one closest estimated wall and an estimated ceiling in the model.

8. The method of claim 1 wherein estimating the location comprises determining amplitude and phase shift for at least first order reflections.

9. The method of claim 1 further comprising, obtaining the estimate of the room model, including estimating the locations of walls including a ceiling by driving a loudspeaker and processing signals corresponding to reflections received by microphones of the microphone array.

10. In an audio processing environment, a system comprising:
a room estimation modeling mechanism, the room estimation modeling mechanism configured to model a room by estimating the locations of walls including a ceiling by driving a loudspeaker and processing signals corresponding to reflections detected by microphones of a microphone array; and
a sound source localization mechanism, the sound source localization mechanism configured to use the room model estimates to estimate a likely location of a sound source within a room, in which the sound source outputs sound including reverberations as detected by the microphones, and the sound source localization mechanism matches actual sound data from the sound source against a plurality of sets of location-predicted sound data including reverberation data computed for a corresponding a plurality of possible locations to estimate the likely location.

11. The system of claim 10 wherein the loudspeaker is geometrically centered relative to the microphones of the array, and wherein the microphones are distributed around the loudspeaker.

12. The system of claim 10 wherein the room estimation modeling mechanism processes the signals into a plurality of functions that each comprise distance, azimuth, elevation, and reflection coefficient data.

13. The method of claim 12 wherein the room estimation modeling mechanism models the room by performing least squares computations on the functions to select reflection coefficients.

14. The system of claim 10 wherein the room estimation modeling mechanism performs L1-regularization to determine a sparse subset of candidate wall locations.

15. The system of claim 14 wherein the room estimation modeling mechanism models the room by selecting, from the candidate wall locations, four walls and a ceiling that correspond to a rectangular or substantially rectangular room.

16. In an audio processing environment, a method performed on at least one processor comprising, outputting a calibration sound in a room, detecting reflections of the calibration sound at a microphone array, processing signals from the microphone array corresponding to the reflections to obtain a plurality of functions corresponding to a set of candidate wall locations, processing the functions to obtain a sparse set of candidate wall locations, and modeling the room from the sparse set of candidate wall locations.

17. The method of claim 16 wherein the functions comprise distance, azimuth and elevation data, and further comprising, performing regularization on the distance, azimuth and elevation data to determine the sparse subset of the candidate wall locations.

18. The method of claim 16 wherein the functions comprise reflection coefficient data, and further comprising, performing least squares computations on the reflection coefficient data to select reflection coefficients for the candidate wall locations.

19. The method of claim 16 wherein modeling the room from the sparse set of candidate wall locations comprises selecting, from the candidate wall locations, four walls and a ceiling that correspond to a rectangular or substantially rectangular room.

20. The method of claim 16 further comprising, outputting a room model comprising estimated wall locations to a sound source localization mechanism, the sound source localization mechanism using the estimated wall locations to compute hypotheses that are based upon reflection data for use in estimating the location of a sound source.
